(19) United States
(12) Patent Application Publication
(10) Pub. No.: US 2019/0317033 A1
(43) Pub. Date: Oct. 17, 2019

(54) IN SITU MICROSCOPY OF ROTATIONALLY DEFORMED SAMPLE

(71) Applicant: Oxford University Innovation Limited, Oxford (GB)

(72) Inventor: Lars HANSEN, Oxford (Oxfordshire) (GB)

(21) Appl. No.: 16/347,618

(22) PCT Filed: Nov. 7, 2017
(86) PCT No.: PCT/GB2017/053337

§ 371 Date: May 6, 2019

(30) Foreign Application Priority Data
Nov. 7, 2016 (GB) 1618755.1

(51) Int. Cl. G01N 23/2251; G01N 3/16; G01N 3/22; G01N 23/2206

(52) U.S. Cl. CPC G01N 23/2251; G01N 3/165; G01N 2223/3306; G01N 23/2206; G01N 2223/071; G01N 3/22

(57) ABSTRACT

A method of observing a solid sample (100) with a microscope (300), comprising engaging a rotating portion (110) with a first part (104) of the sample (100), holding a second part (106) of the sample (100), and rotating the rotating portion (110) so as to rotate the first part (104) of the sample (100) relative to the second part (106) of the sample (100).

This invention relates to observing materials with a microscope, particularly their behaviour under stress.

In situ microscopy involves observing samples with a microscope whilst one or more parameters of the sample are varied. One common technique is to deform samples by stretching them, allowing the deformation process of samples to be characterised. However, the elongation process changes the size of a sample. As the space available on the stage of a microscope is limited, there is an upper limit on how much a sample can be elongated. This limits the spectrum of material behaviour that can be investigated.

Elongating materials by stretching can also result in sample failure after small deformations.

The present invention aims to address these issues and when viewed from a first aspect provides a method of observing a solid sample with a microscope, comprising engaging a rotating portion with a first part of the sample, holding a second part of the sample, and rotating the rotating portion so as to rotate the first part of the sample relative to the second part of the sample.

This aspect of the invention extends to an apparatus arranged to observe a sample with a microscope, comprising a rotating portion which can be engaged with a first part of the sample and a fixing arrangement configured to fix a second part of the sample in place, wherein the rotating portion is configured to rotate the first part of the sample relative to the second part of the sample.

Thus it will be seen that in accordance with the invention a sample is twisted rather than being stretched linearly. This ensures that the sample does not change substantially in size when deformed, allowing significantly greater deformations to be applied to samples than with elongation deformation processes as the deformation is not limited by the size of the microscope's stage. Furthermore, as the sample does not change shape, the chance of sample failures is decreased.

The rotating portion may rotate the first part of the sample relative to the second part in situ. Deformations can therefore occur without removing the sample from the microscope stage. The deformation can thus be observed in real-time by the microscope, meaning parts of the deformation process are not missed.

Conveniently, no part of the sample is obscured from the view of the microscope. The whole sample can therefore be observed by the microscope before, during and after rotational deformation. If parts of the sample were obscured from view from the microscope, the characterisation process may be incomplete.

In a set of embodiments, the first part of the sample is on the interior of the sample rather than the periphery.

In a set of embodiments, the rotating portion engages the first part of the sample via at least one recess in the sample. Such engagement could comprise any suitable engaging technique, such as, but not limited to, bonding, adhesive, clamping or mechanical fit.

In a set of embodiments, the rotating portion comprises a non-circular keying cross-section arranged to engage a corresponding key slot in the first part of the sample using a keying mechanism. A keying mechanism may provide a simple and robust way to transfer torque from the rotating device to the sample.

The rotating key slot could comprise a variety of suitable shapes, such as, but not limited to, a regular polygon, a star polygon, a triangle, quadrilateral, pentagon, hexagon, heptagon, octagon, circle, or circular shape. The rotating portion will typically have the same shape for maximum engagement, but it is envisaged that certain non-identical shapes can also provide a positive mechanical engagement in certain key slot shapes.

The recess could be closed on one face of the sample, but in a set of embodiments the rotating portion is arranged to engage the first part of the sample via a shaft passing through a cooperating hole in the first part of the sample. A plurality of shafts and a plurality of cooperating holes could be used.

The second part of the sample could be held by a clamp or the like. Additionally or alternatively in a set of embodiments, the second part of the sample is held using a keying mechanism. This may equally provide a robust way of preventing the second part of the sample rotating when the first part of the sample has a torque applied to it. The key slot could comprise a variety of suitable shapes, such as, but not limited to, a regular polygon, a star polygon, a triangle, quadrilateral, pentagon, hexagon, heptagon, octagon, circle, or circular shape. An elongate slot open at one end could be provided to engage samples of different lengths/widths. Equally an adjustable slot could be used and/or a variety of key slots could be provided for differently shaped and sized samples. The key slot could be interchangeable upon the microscope stage to facilitate using different key slot shapes and sizes. Interchangeable key slots also provide the benefit of allowing key slots to be replaced easily if they become worn down through use.

The key slot could comprise diamond, silicon carbide, tungsten, or any other suitably strong material which could withstand strong rotational forces as required to hold the second part of the sample in place.

It will be appreciated by those skilled in the art that whilst the foregoing discussion assumes that the rotating portion engages the interior of the sample and rotates relative to the rest of the microscope (such as the stage etc), this is not essential as only relative rotation between parts of the sample is required. This can of course be achieved by engagement between a portion of the microscope fixed relative to the rest of the microscope and rotating the sample stage. In such an arrangement the recited first part of the sample would alternatively be on the periphery thereof and the second part on the interior. The description above relating to the rotating portion would then apply to the fixed portion and the description above relating to holding the sample would apply to the rotating portion.

The rotating or fixed portion engaging the centre of the sample could comprise diamond, silicon carbide, tungsten, or any other suitably strong material which could withstand strong rotational forces as required to rotate the first part of the sample relative to the second part of the sample.

In a set of embodiments, the temperature of the sample is varied. In a set of embodiments this achieved by providing a heating element. Varying the temperature of the sample allows temperature-dependent processes to be studied as well as rotational deformation processes. Studying these processes allows a larger parameter space to be characterised for samples, increasing understanding of the microphysical behaviour of studied samples. Other characteristics of samples could also be studied alongside rotational deformation and temperature dependence, such as, but not limited to, chemical and electrical responses.

In a set of embodiments, the microscope is an electron microscope. The electron microscope may optionally be a scanning electron microscope.

In a set of embodiments, the sample has an upper surface area of less than 100 square centimetres, preferably less than 50 square centimetres, more preferably less than 25 square centimetres, most preferably less than 10 square centimetres. The sample and fixing arrangement should be suitably small such as to fit on the stage of a microscope, and especially on the stage of a scanning electron microscope.

In a set of embodiments, the first part of the sample is rotated relative to the second part of the sample by more than 10 degrees, e.g. more than 45 degrees, e.g. more than 90 degrees, e.g. more than 180 degrees, e.g. more than 360 degrees, e.g. more than 720 degrees, e.g. more than 1080 degrees, e.g. more than 1800 degrees, e.g. more than 3600 degrees. By rotating the first part of the sample relative to the second part of the sample by greater amounts, a greater range of rotational deformation can be characterised. The range of rotation of the first part of the sample relative to the second part of the sample may not be limited.

When viewed from a second aspect, this invention provides a method of observing a sample using in situ microscopy comprising rotationally deforming the sample. This aspect of the invention extends to an apparatus for in situ microscopy arranged to deform samples rotationally. In a set of embodiments the microscope is an electron microscope, preferably a scanning electron microscope.

Certain embodiments of the invention will now be described, by way of example only, with reference to the accompanying drawings, in which:

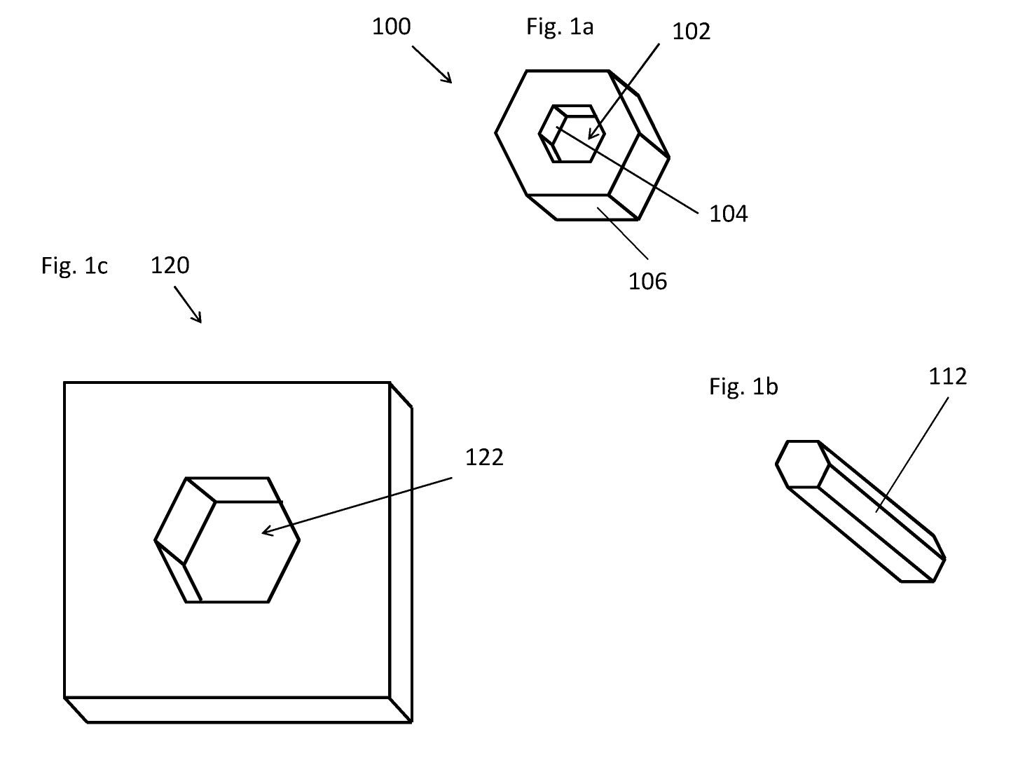

FIG. 1a is a perspective view of a sample with a hexagonal shape for use in accordance with an embodiment of the invention;

FIG. 1b is a perspective view of a rotating portion with a hexagonal shape;

FIG. 1c is a perspective view of a sample holder with a hexagonal shape;

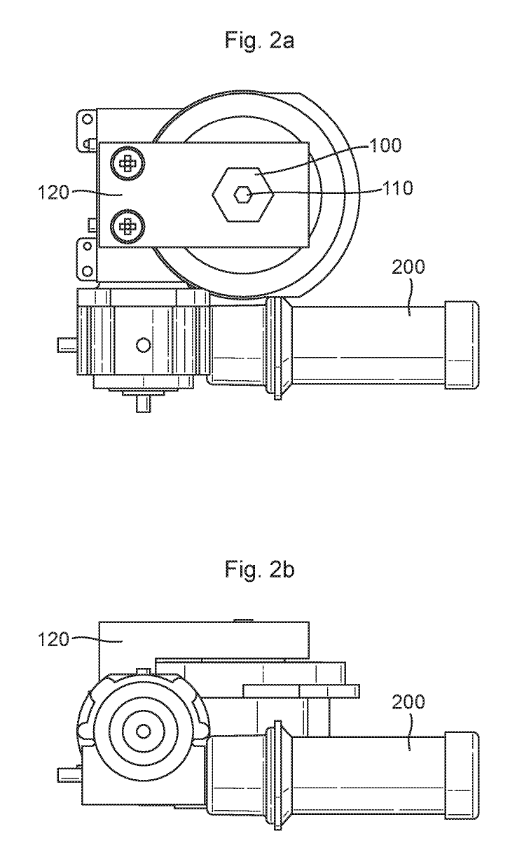

FIG. 2a is a top-view drawing of a sample holder, sample and rotating portion;

FIG. 2b is a side-view drawing of a sample holder, sample and rotating portion;

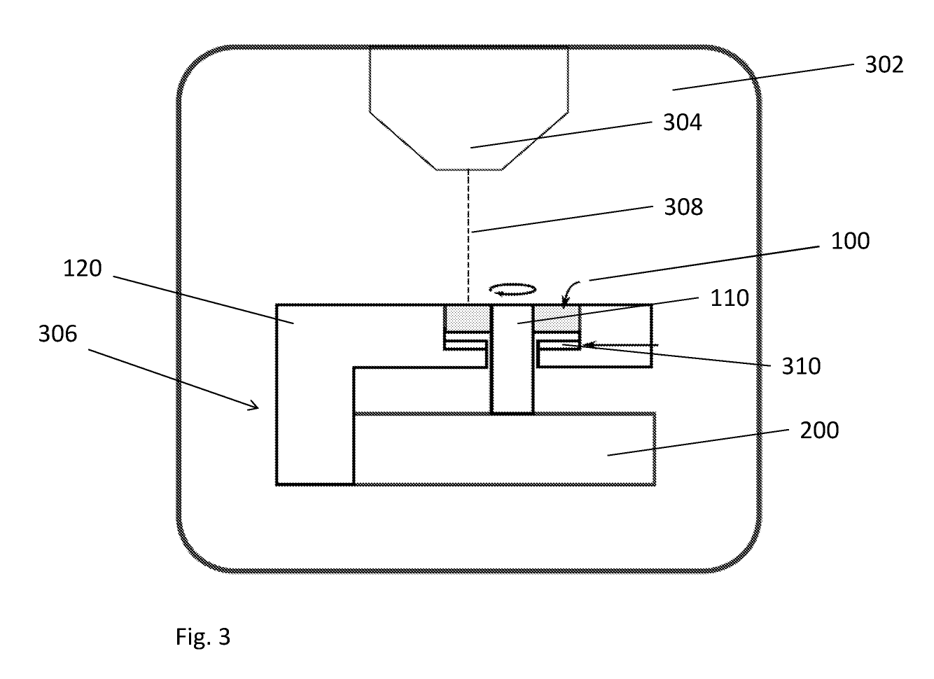

FIG. 3 is a schematic diagram of a scanning electron microscope in accordance with the invention;

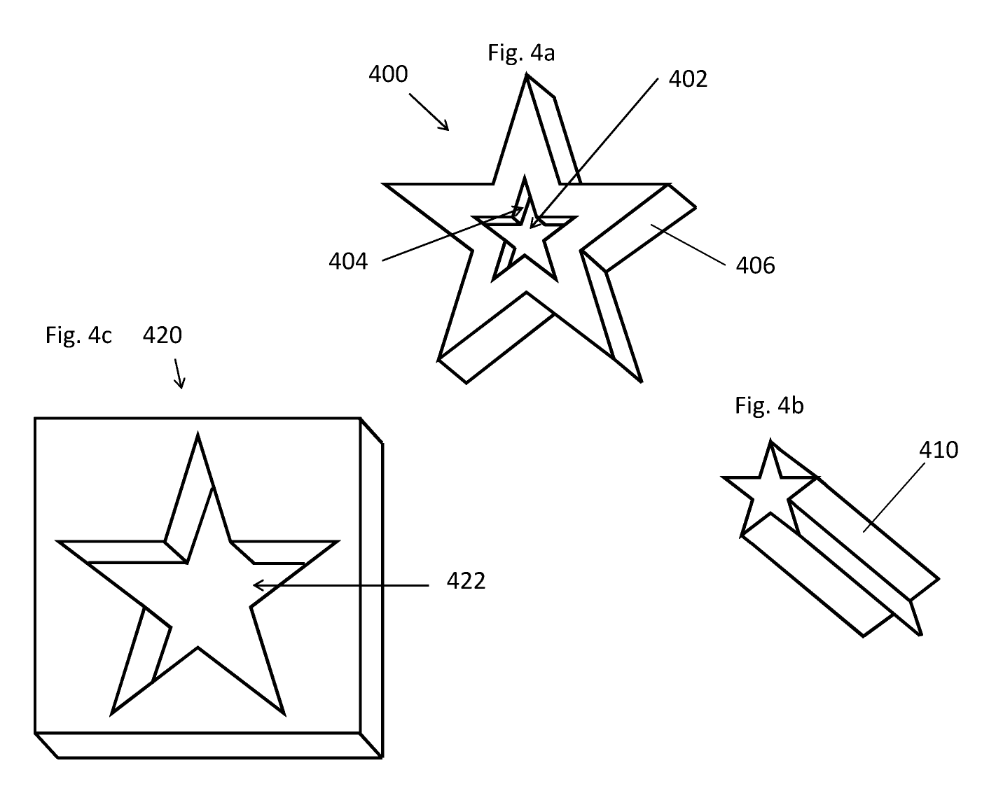

FIG. 4a is a perspective view of a sample with a star polygon shape;

FIG. 4b is a perspective view of a rotating portion with a star polygon shape;

FIG. 4c is a perspective view of a sample holder with a star polygon shape.

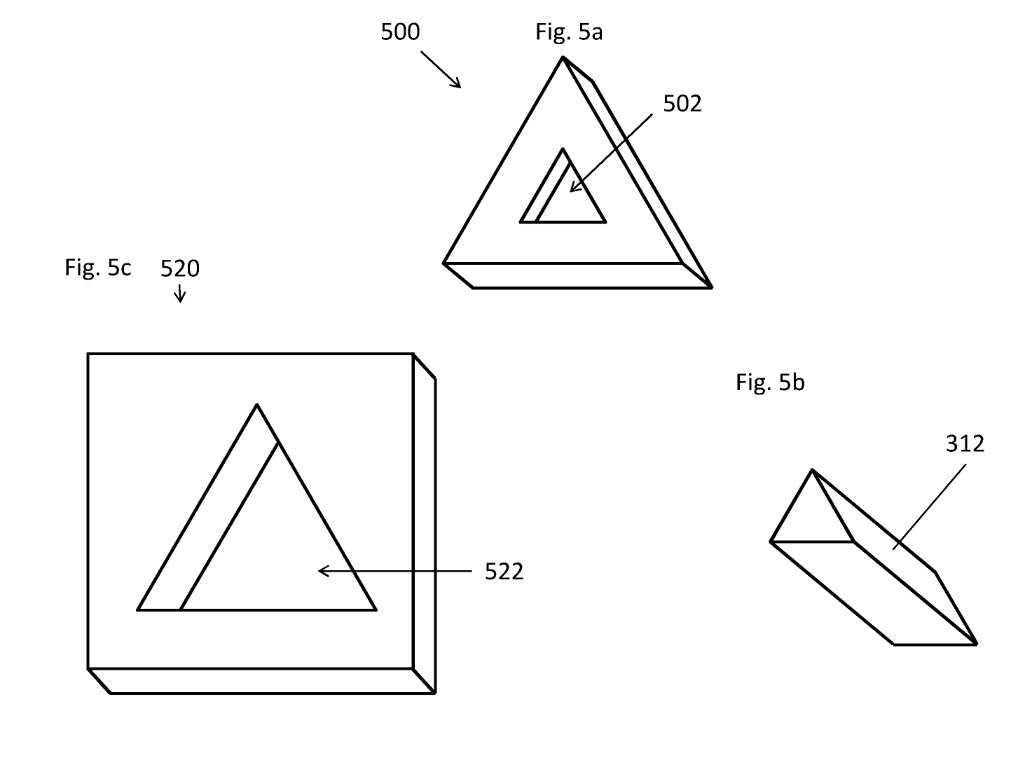

FIG. 5a is a perspective view of a sample with a triangular shape;

FIG. 5b is a perspective view of a rotating portion with a triangular shape;

FIG. 5c is a perspective view of a sample holder with a triangular shape; and

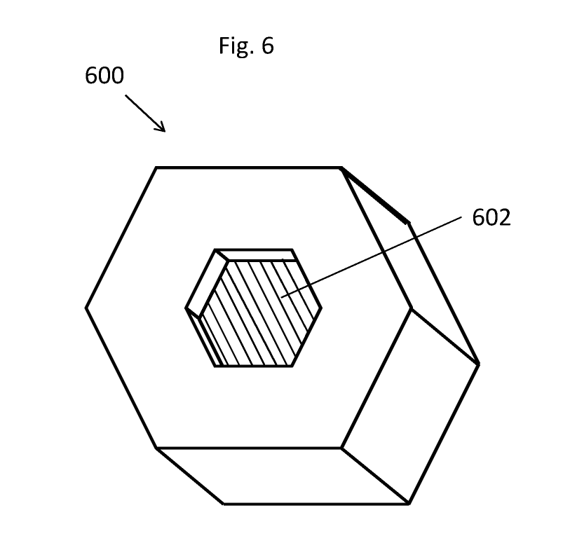

FIG. 6 is a perspective view of a sample with a recess.

FIG. 1a shows schematically a perspective view of a sample 100 for in situ microscopy in accordance with an embodiment of the present invention. The sample 100 is hexagonal in shape and comprises a central hexagonal hole 102. The inner part 104 can be defined as a first part of the sample 104, and the outer part 106 as a second part of the sample.

FIG. 1b shows a perspective view of a shaft 110 which provides a rotating portion of the microscope. The shaft 110 is shaped as to fit tightly into the cooperating hole 102 of the sample. The shaft is made of a suitably strong material to withstand strong rotational forces.

FIG. 1c shows a perspective view of a sample holder 120 of the microscope. A key slot 122 is located at the centre of the sample holder 120. The key slot 122 is a hole defined in the sample holder 120 in the shape of the outer, second part of the sample 106, in order to receive and hold the sample snugly. The sample holder 120 is made of a suitably strong material to withstand strong rotational forces.

FIGS. 2a and 2b show plan and side elevation views respectively of the sample manipulation part of the microscope. This shows the sample 100 retained in the key slot 122, with the rotating shaft 110 passing through and engaging the cooperating hole 102. A rotary motor 200 is coupled to the shaft 110 in order to drive it.

With reference to the diagram of FIG. 3, it can be seen that the parts shown in FIGS. 2a and 2b form part of an electron microscope 300. The microscope comprises a chamber 302 which houses an electron pole piece 304 and a sample stage 306 comprising the sample holder 120, rotary motor 200 and rotating shaft 110 which passes through a hole in the centre of the sample 100 as previously described. The sample 100 has a surface area of less than 10 square centimetres and so is small enough to be accommodated within a standard scanning electron microscope chamber 302 so that all of the surface of the sample 100 can be addressed by the electron beam 308. A heating element 310 is incorporated into the sample holder 120 which can be used to vary the temperature of the sample 100 during analysis.

In use the scanning electron microscope beam 308 is activated to observe the sample 100. During this observation the shaft 110 is rotated by the rotary motor 200. As may be appreciated from FIG. 3, the sample holder 120 and shaft 110 do not obscure the view of the sample 100 from above. Therefore the scanning electron microscope 300 can view the whole of the sample 100 without the need to account for foreground objects.

As the shaft 110 rotates it applies a torque to the central part of the sample 104 whilst the outer, second part of the sample 106 is held by the key slot 122. A velocity gradient is thus imposed along the sample 100, deforming it. The electron microscope 300 can image the sample 100 during the deformation process, i.e. in situ. The sample 100, shaft 110, sample holder 120 and rotary motor 200 do not change in size during the deformation process, hence the size of the electron microscope's stage 302 does not impose a limit on the amount of deformation that can occur. Depending on the material of the sample 100 it might be possible, for example, to deform it by ten complete revolutions before it fractures or other failure occurs.

Heating the sample 100 with the heating element 310 allows temperature-dependence of the sample's deformation process to be observed.

The shaft 110 and key slot 122 are designed so as to be interchangeable and replaceable. This allows worn shafts 110 and/or worn key slots 122 to be replaced. It also allows shafts 110 and key slots 122 of different shapes to be used, depending on the shape of the hole 102 and the outer edge of the sample.

FIG. 4a shows a sample 400 in accordance with another embodiment of the invention having a star polygon shape. The central hole 402 defined by the interior part of the sample 404 and the outer surface of the sample 406 are also star shaped. In FIG. 4b the shaft 410 has a matching star shape. In FIG. 4c the key slot 422 of the sample holder 420 also has a triangular shape. It will be appreciated that it is not essential of course that the inner hole and outer surface have the same shape—e.g. a triangular-shaped central hole and hexagonal-shaped key slot could be used.

FIG. 5a shows another embodiment of a sample 500 with a triangular shape. The central hole 502, shaft 510 and key slot 522 of the sample holder 520 also have a triangular shape.

FIG. 6 shows an alternative embodiment of a sample 600 which has a closed recess 602 rather than a hole passing all the way through it. This may engage with a hexagonal-section shaft similar to that shown in FIG. 1b but shorter.

Thus it will be seen that embodiments of the invention allow samples to be deformed which permits the deformation processes of the samples to be characterised. In contrast with samples being stretched, where the amount of deformation by elongation is limited, typically by the space available of the stage of a microscope, this means that deformation is not limited by space on a microscope stage.

1. A method of observing a solid sample with a microscope, comprising engaging a rotating portion with a first part of the sample, holding a second part of the sample, and rotating the rotating portion so as to rotate the first part of the sample relative to the second part of the sample.

2. The method as claimed in claim 1 wherein the first part of the sample is on the interior of the sample.

3. The method as claimed in claim 1 wherein the rotating portion engages the first part of the sample via at least one recess in the sample.

4. The method as claimed in claim 1 wherein the rotating portion comprises a non-circular keying cross-section engaging a corresponding key slot in the first part of the sample using a keying mechanism.

5. The method as claimed in claim 1 wherein the rotating portion engages the first part of the sample via a shaft passing through a cooperating hole in the first part of the sample.

6. The method as claimed in claim 1 wherein the second part of the sample is held using a keying mechanism.

7. The method as claimed in claim 1 comprising varying the temperature of the sample.

8-9. (canceled)

10. The method as claimed in claim 1 wherein the sample has an upper surface area of less than 100 square centimetres.

11. The method as claimed in claim 1 comprising rotating the first part of the sample relative to the second part of the sample by more than 10 degrees.

12. An apparatus arranged to observe a sample with a microscope, comprising a rotating portion which can be engaged with a first part of the sample and a fixing arrangement configured to fix a second part of the sample in place, wherein the rotating portion is configured to rotate the first part of the sample relative to the second part of the sample.

13. The apparatus as claimed in claim 12 wherein the first part of the sample is on the interior of the sample.

14. The apparatus as claimed in claim 12 wherein the rotating portion is arranged to engage the first part of the sample via at least one recess in the sample.

15. The apparatus as claimed in claim 12 wherein the rotating portion comprises a non-circular keying cross-section arranged to engage a corresponding key slot in the first part of the sample using a keying mechanism

16. The apparatus as claimed in claim 12 wherein the rotating portion is arranged to engage the first part of the sample via a shaft passing through a cooperating hole in the first part of the sample.

17. The apparatus as claimed in claim 12 comprising a key slot to hold the second part of the sample using a keying mechanism.

18. The apparatus as claimed in claim 17 wherein the key slot is adjustable

19. The apparatus as claimed in claim 17 wherein the key slot is interchangeable.

20. The apparatus as claimed in claim 12 comprising means for varying the temperature of the sample.

21-22. (canceled)

23. The apparatus as claimed in claim 12 arranged to rotate the first part of the sample relative to the second part of the sample by more than 10 degrees.

24. A scanning electron microscope comprising the apparatus as claimed in claim 12.

25-26. (canceled)
